(19) United States
(12) Patent Application Publication
(10) Pub. No.: US 2020/0007261 A1
(43) Pub. Date: Jan. 2, 2020

(54) RADIO-OVER-FIBER COMMUNICATION BEAMFORMING DEVICE BASED ON ARRAYED WAVEGUIDE GRATING AND METHOD THEREOF

(71) Applicant: SOUTHWEST JIAOTONG UNIVERSITY, Chengdu (CN)

(72) Inventors: Xihua ZOU, Chengdu (CN); Peixuan LI, Chengdu (CN); Wei PAN, Chengdu (CN)

(73) Assignee: SOUTHWEST JIAOTONG UNIVERSITY, Chengdu (CN)

(21) Appl. No.: 16/482,247

(22) PCT Filed: Dec. 18, 2017
(86) PCT No.: PCT/CN2017/116910

§ 371 Date: Jul. 30, 2019

(30) Foreign Application Priority Data
Nov. 15, 2017 (CN) 201711126995.6

(51) Int. Cl. H04J 14/02; H04B 10/2575; H04B 10/50; H04B 7/06

(52) U.S. Cl. CPC H04J 14/0205; H04B 10/2575; H04B 7/0617; H04B 10/506; H04B 10/503

(57) ABSTRACT

A radio-over-fiber communication beamforming device based on arrayed waveguide grating and a method thereof. The radio frequency signal is modulated onto a plurality of optical carriers of different wavelengths and processed by a programmable photonic true-time delay module in the optical domain. The programmable photonic true-time delay module includes optical switches and a plurality of cascaded AWGs which can provide different basic delays between adjacent wavelength channels. The basic delays of different stages of the AWG present a geometric sequence with a common ratio of 2. Optical carriers of different wavelengths enter different branches and undergo photoelectric conversion to obtain the radio frequency signals of different delays (phases) to realize a far-field beam directional radiation pattern.

### CROSS REFERENCE TO THE RELATED APPLICATIONS

This application is the national phase entry of International Application No. PCT/CN2017/116910, filed on Dec. 18, 2017, which is based upon and claims priority to Chinese Patent Application No. 201711126995.6, filed on Nov. 15, 2017, the entire contents of which are incorporated herein by reference.

### TECHNICAL FIELD

The present invention relates to radio-over-fiber communication systems, and particularly to a beamforming device based on photonic true-time delay and a method thereof.

### BACKGROUND

Beamforming techniques can achieve spatial concentration of radio frequency signals in a particular direction by controlling the amplitude and phase of elements in an antenna array (directional radiation pattern of beams) and have the advantages of reduced signal transmission losses, increased coverage, and reduced interference to the nearby signal receiving ends caused by energy diffusion. Therefore, the beamforming techniques have been widely applied in the field of radio frequency and microwave, such as radar, wireless communication, etc. However, limited by “electronic bottlenecks” and instantaneous bandwidth, the existing beamforming techniques based on electronic approaches cannot satisfy the requirements in developing the radar techniques and next-generation wireless communication techniques. Typically, for example, in fifth-generation wireless communication technique (5G), in order to achieve a wireless communication capacity 1000 times larger than the existing 4G technique, the frequency band in 5G communication is inevitably advancing toward millimeter wave band with higher frequency. The United States and Canada successively assigned spectrum bands including 28 GHz, 37 GHz, 38 GHz, and 64-71 GHz for 5G applications in 2016 and 2017. While, in the high-speed railway system, in order to provide high-speed wireless access to passengers traveling with the high-speed railway, the solution of expanding the communication capacity based on high-frequency millimeter waves for the high speed railway has also been widely concerned. (H. Song, X. Fang, Y. Fang, “Millimeter-wave network architectures for future high-speed railway communications: challenges and solutions,” IEEE Wireless Communications, vol. 23, no. 6, pp. 114-112, 2016; P. T. Dat, A. Kanno, T. Kawanishi, “Energy and deployment efficiency of a millimeter-wave Radio-on-Radio-over-fiber system for railways,” Optical Fiber Communication Conference, Optical Society of America, 2013: JTh2A. 61).

As the radio-over-fiber technology continues to evolve, the expectation of replacing the existing bandwidth-limited electronic technique with the beamforming technique based on photonic true-time delay, which is characterized in a full utilization of the anti-electromagnetic interference property of the photonic technique, light weight, small size, low loss, large bandwidth, etc., to meet the beamforming requirements of high-frequency carrier waves has made the beamforming technique based on photonic true-time delay a hot research area. Nowadays, based on different group delay control methods, the beamforming techniques based on photonic true-time delay are mainly classified as: the delay induced by the physical size, e.g. using spatial optics (Y. Shi and B. L. Anderson, “Robert cell-based optical delay elements for white cell true-time delay devices,” Journal of Lightwave Technology, vol. 31, no. 7, pp. 1006-1014, 2013), and waveguide medium such as optical fiber and the like (R. D. Esman, M. Y. Frankel, J. L. Dexter, L. Goldberg, M. G. Parent, D. Stilwell, and D. G. Cooper, “Fiber-optic prism true time-delay antenna feed,” IEEE Photonic Technology Letter, vol. 5, no. 11, pp. 1347-1349, November 1993); and the group delay induced by the optical filters such as fiber Bragg gratings or other physical effects (Y. Liu, J. P. Yao, and J. Yang, “Wideband true-time-delay unit for phased array beamforming using discrete-chirped fiber grating prism,” Optics Communication, vol. 207, no. 1-6, pp. 177-187, 2002; P. Berger, J. Bourderionnet, F. Bretenaker, D. Dolfi, and M. Alouini, “Time delay generation at high frequency using SOA based slow and fast light,” Optics. Express, vol. 19, no. 22, pp. 21180-21188, 2011.).

It should be noted that, on the downside, the above-mentioned photonic beamforming solutions all have bulky size and difficulty in integration. While, the photonic true-time delay device based on multi-input multi-output port arrayed waveguide grating (AWG) has been widely concerned due to its small size and easy integration (Z. Cao, Q. Ma, A. B. Smolders, Y. Jiao, M. J. Wale, C. W. Oh, H. Wu, and A. M. J. Koonen, “Advanced integration techniques on broadband millimeter-wave beam steering for 5G wireless networks and beyond,” IEEE Journal of Quantum Electronics, vol. 52, no. 1, article: 0600620, January 2016). In addition, the above solutions also have difficulty in adjusting the time delay difference between different channels. In some dynamic scenarios like high speed railways, the radiation direction of the radio-frequency signal varies dynamically according to the movement of the train so the lack of flexibility will greatly limit the application range of the photonic beamforming solution.

### SUMMARY

In view of the advantages of the photonics technique in beamforming, it is an objective of the present invention to provide a radio-over-fiber communication beamforming device based on arrayed waveguide grating. The present invention aims to facilitate the adjustment of the time delay difference between different channels, so that the radiation direction of the radio frequency signal can vary dynamically in line with the change of the actual application scenarios, so as to meet the beamforming requirements of medium and high frequency microwaves/millimeter waves in dynamic scenarios such as 5G, high-speed railway, etc. Moreover, the multi-input multi-output arrayed waveguide grating is used as the basic delay unit, which has the advantages of small size and easy integration.

The objective of the present invention is realized by the following means.

A radio-over-fiber communication beamforming device based on an arrayed waveguide grating includes a multi-source laser array, a first wavelength division multiplexer, an electro-optic modulator, a programmable photonic true-time delay module, a second wavelength division multiplexer, a photoelectric detector set, and an antenna array. The multi-source laser array, the first wavelength division multiplexer, the electro-optic modulator, the programmable photonic true-time delay module, the second wavelength division multiplexer, the photoelectric detector set, and the antenna array are successively connected to one another in a cascading manner. The programmable photonic true-time delay module is formed by connecting a 1^{st} optical switch, a 1^{st}-stage arrayed waveguide grating, a 2^{nd} optical switch, a 2^{nd}-stage arrayed waveguide grating, . . . , an N^{th} optical switch, an N^{th}-stage arrayed waveguide grating, and an (N+1)^{th} optical switch. The first output port of the 1^{st} optical switch is connected to the first input port of the 1^{st}-stage arrayed waveguide grating, the second output port of the 1^{st} optical switch is connected to the second input port of the 2^{nd} optical switch, the first output port of the 1^{st}-stage arrayed waveguide grating is connected to the first input port of the 2^{nd} optical switch, and all remaining of the optical switches and arrayed waveguide gratings are configured in the same way. Each stage of the arrayed waveguide gratings has multiple input ports and multiple output ports. In addition to the first input port of the arrayed waveguide grating being connected to the optical switch ahead of arrayed waveguide grating and the first output port of the arrayed waveguide grating being connected to the optical switch behind the arrayed waveguide grating, the second input port of the same arrayed waveguide grating is connected to the second output port of the same arrayed waveguide grating, and the third input port of the same arrayed waveguide grating is connected to the third output port of the same arrayed waveguide grating, and all remaining of input and output ports of the arrayed waveguide gratings are configured in the same way.

The multi-source laser array is configured to output a plurality of continuous optical carriers of different wavelengths.

The first wavelength division multiplexer is configured to synthesize the plurality of continuous optical carriers of different wavelengths outputted by the multi-source laser array into one output.

The electro-optic modulator is configured to modulate and output the output signal of the first wavelength division multiplexer by a radio frequency signal.

The programmable photonic true-real time delay module is configured to realize a final delay difference between the optical carriers of different wavelengths in the output signal of the electro-optic modulator by different combinations of on or off of the optical switches according to control requirements.

The second wavelength division multiplexer is configured to process the output signal of the programmable photonic true-time delay module and output optical carriers of different wavelengths.

The photoelectric detector set and the antenna array are configured to perform a photoelectric conversion on the output signal of the second wavelength division multiplexer to obtain radio frequency signals of different delays or different phases, and the radio frequency signals are transmitted through the antenna array to form a far-field beam directional radiation pattern.

Another objective of the present invention is to provide a radio-over-fiber communication beamforming method of the above system.

The second objective of the present invention is realized by the following means.

A radio-over-fiber communication beamforming method based on a multi-input multi-output port arrayed waveguide grating uses a device including a multi-wavelength continuous laser source array, wavelength division multiplexers, an electro-optic modulator, a light switch, a plurality of cascaded multiple-input multiple-output arrayed waveguide gratings, a photoelectric detector set, and an antenna array. The method mainly includes the following steps: outputting a plurality of continuous optical carriers of different wavelengths from the multi-wavelength continuous laser source array, and synthesizing the continuous optical carriers into one output by one of the wavelength division multiplexers to enter the electro-optic modulator and be modulated by a radio frequency signal, and then inputting the modulated output to the programmable photonic true-time delay module. The programmable photonic true-time delay module includes optical switches and a plurality of cascaded multi-input multi-output port arrayed waveguide gratings. The final delay difference between waves of different wavelengths is determined by the combinations of on and off states of the optical switches. The optical signal processed by the programmable photonic true-time delay module is further processed by another one of the wavelength division multiplexers, and the optical carriers of different wavelengths enter different branches respectively and undergo a photoelectric conversion by the photoelectric detector set to obtain radio frequency signals of different delays or different phases, and the radio frequency signals are transmitted through the antenna array to form a far-field beam directional radiation pattern.

For the arrayed waveguide gratings not of the same stage, the basic delays Δτ between adjacent wavelength channels present as a geometric sequence with a common ratio of 2. In a structure of a plurality of arrayed waveguide gratings connected in a cascading manner, the basic delays of adjacent wavelength channels are Δτ, 2Δτ, 4Δτ, 8Δτ, . . . , 2^{N-1}Δτ, respectively, and N is the number of the cascading.

With the combination of the on and off states of the optical switches, a total of 2^{N} different combinations of the basic delays between the adjacent wavelength channels can be realized in the multi-stage structure with N-stage arrayed waveguide gratings, the 2^{N} combinations include 0, Δτ, 2Δτ, 3Δτ, . . . , (2^{N}−1)Δτ, respectively, so that 2^{N} different far-field beam directional radiation patterns and their tuning are realized.

Compared with the prior art, the present invention has the following features and advantages.

1). Based on the radio-over-fiber technique, the present invention has a simple structure benefited by the large bandwidth and low losses of the photonic technique, so that the beamforming of the radio frequency signals in a wide frequency band range can be realized, thereby transcending the bandwidth limitation of electronics-based solutions due to “electronic” bottlenecks.

2). The basic delay unit based on the multi-input multi-output arrayed waveguide gratings has the advantage of small size and easy integration.

3). 2^{N} delay combinations can be realized with the N-stage cascaded structure by simply controlling the combination of the on and off states of the optical switches in the photonic true-time delay module, thereby achieving 2^{N} far-field radiation patterns, which can be widely used in the dynamic scenarios such as high speed railways, etc.

### BRIEF DESCRIPTION OF THE DRAWINGS

FIG. 1 is a block diagram showing the hardware of the system of the present invention;

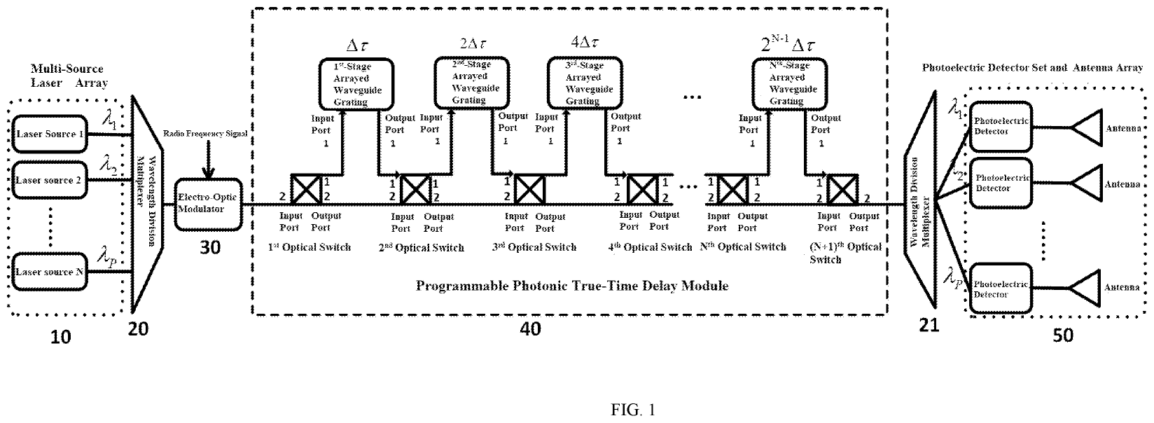

FIG. 2 is a schematic diagram of a single-stage multiple-input multi-output arrayed waveguide grating that contributes to from a programmable photonic true-time delay module;

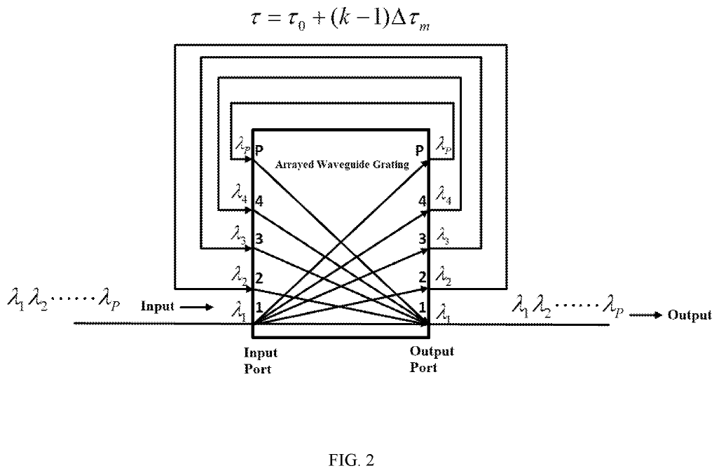

FIG. 3 is a schematic diagram of multi-stage arrayed waveguide gratings; and

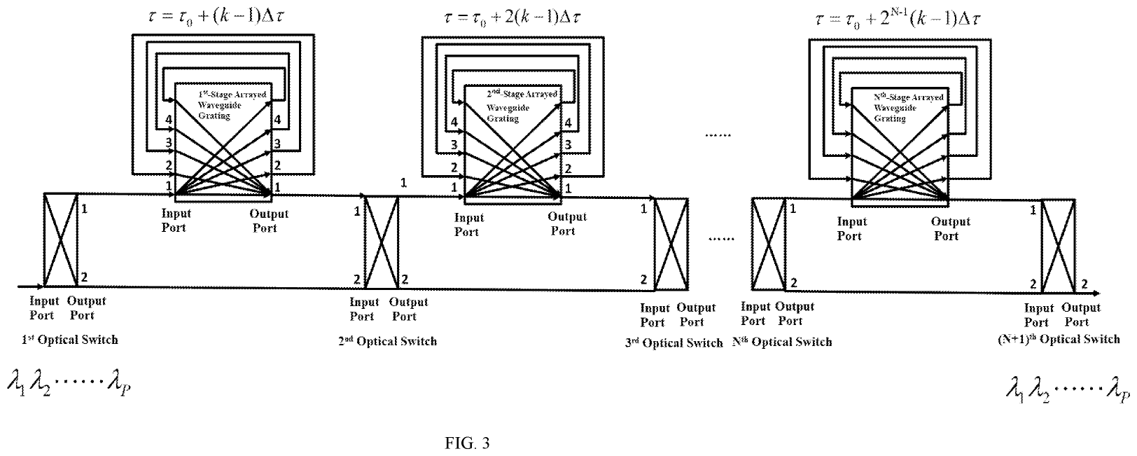

FIG. 4 shows the example of delay with a combination of optical switches of a four-stage structure.

### DETAILED DESCRIPTION OF THE EMBODIMENTS

The implementations of the present invention will be further described hereinafter with reference to the drawings.

A radio-over-fiber communication beamforming system based on a multi-input multi-output port arrayed waveguide grating (AWG) includes the multi-wavelength continuous laser source array 10, the wavelength division multiplexers 20, the electro-optic modulator 30, the photonic true-time delay module 40, the photoelectric detector set, and the antenna array 50. According to the proposed method, the radio frequency signals are modulated onto a plurality of carriers of different wavelengths and processed in the optical domain by the photonic true-time delay module capable of programming the wideband. The photonic true-time delay module includes optical switches and a plurality of cascaded AWGs that can provide the basic delays between adjacent wavelength channels. The basic delays of the AWGs not of the same stage present as a geometric sequence with a common ratio of 2. Finally, carriers of different wavelengths enter different branches, and after the photoelectric conversion of these branches, the radio frequency signals of different delays (phases) are obtained to realize a far-field beam directional radiation pattern (beamforming). Simply by controlling the combination of the on and off states of the optical switches in the photonic true-time delay module, the present invention can realize a combination of 2^{N} delays with a multi-stage cascaded AWG, thereby achieving 2^{N} different far-field beam directional radiation patterns (beamforming) and the tuning thereof, N refers to the number of cascading. The processing steps are as follows: a plurality of continuous optical carriers of different wavelengths are output from the laser source array 10 and are synthesized into one by one of the wavelength division multiplexers 20. Then the synthesized output enters the electro-optic modulator 30 to be modulated by a radio frequency signal, and then input to the programmable photonic true-time delay module 40. The photonic true-time delay module 40 includes optical switches and N cascaded multi-input multi-output port arrayed waveguide gratings. The final delay difference between different wavelengths is determined by the combination of the on and off states of the optical switches. After the optical signal processed by the programmable photonic true-time delay module is processed by another one of the wavelength division multiplexers 21. The optical carriers of different wavelengths enter different branches respectively and undergo a photoelectric conversion by the photoelectric detector set to obtain radio frequency signals of different delays or different phases. The radio frequency signals are transmitted through the antenna array 50 to form the far-field beam directional radiation pattern.

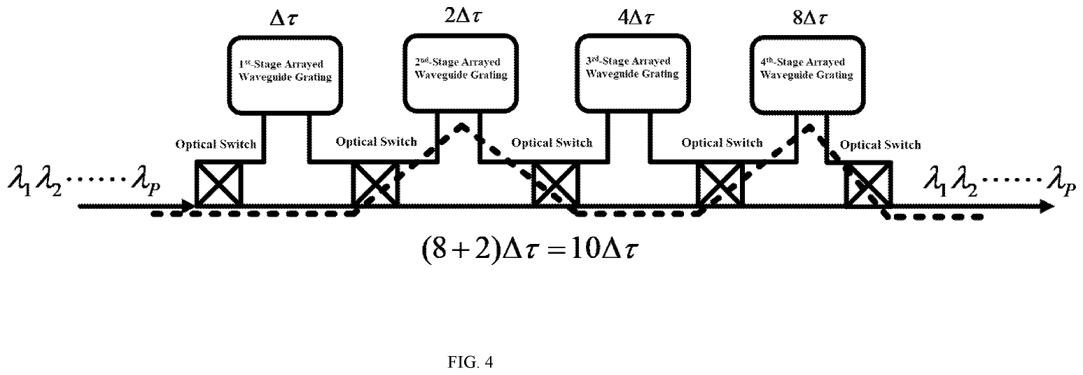

The practical implementation process is as follows: the optical carriers of multiple wavelengths are output from the continuous laser source array and are multiplexed by the wavelength division multiplexer. The multiplexed optical field E₁ (t) can be expressed as:

$${E}_{1} ( t ) = {\sum }_{k = 1}^{P} {A}_{k} exp j {ω}_{k} t \qquad ( 7 )$$

where, P is the number of laser sources or elements in the antenna array, Aₖ is the amplitude of the different optical carriers, ωₖ is the angular frequency of the different optical carriers, t is the time variable, and j is the imaginary unit (i.e., j=\sqrt{−1}). The multiplexed optical signal entering the electro-optic modulator undergoes the intensity modulation by the transmitted radio frequency signal, and at this time, the electric field E₂(t) of the optical signal can be expressed as:

$${E}_{2} ( t ) \approx \sqrt{s ( t )} {\sum }_{k = 1}^{P} {A}_{k} exp j {ω}_{k} t \qquad ( 8 )$$

where s(t) is the input radio frequency signal. The optical signal shown in the formula (8) is input to the photonic true-time delay module, and the optical switches determine whether the optical signal can enter the arrayed waveguide grating of different stages. In the arrayed waveguide gratings, the optical carriers of different wavelengths have different delays. For example, the optical carrier of the k^{th} wavelength has a delay of τ=τ₀+(k−1)Δτₘ, where Δτₘ represents a basic delay between adjacent wavelength channels of the m^{th}-stage arrayed waveguide grating. Therefore, ignoring the constant delay τ₀, the optical signal E₃(t) processed by the photonic true-time delay module can be expressed as:

$${E}_{3} ( t ) = {\sum }_{k = 1}^{P} {A}_{k} exp j {ω}_{k} [ t + ( k - 1 ) {\sum }_{m = 0}^{N - 1} {q}_{m} {2}^{m} Δτ ) ] \sqrt{s [ t + ( k - 1 ) {\sum }_{m = 0}^{N - 1} {q}_{m} {2}^{m} Δτ ]} \qquad ( 9 )$$

where Δτ is a basic delay between adjacent wavelength channels of the 1^{st}-stage arrayed waveguide grating, and qₘ is 0 or 1 to indicate whether the optical signal is allowed to enter the corresponding arrayed waveguide grating or not by the optical switches. Taking the four-stage cascaded structure in FIG. 4 as an example, when the second and fourth optical switches are controlled to be turned on, and the other switches are turned off, the optical signal can merely pass through the second and fourth arrayed waveguide gratings, and the final basic delay difference between different wavelengths is 10Δτ.

Subsequently, the wavelength division multiplexer divides the optical carriers of different wavelengths and their carried radio frequency signals to enter different branches. After the photoelectric conversion, the radio frequency signal recovered in each branch is expressed as:

sₖ(t)=s[t+(k−1)Δτ′)] (10)

where Sₖ(t) represents the radio frequency signal recovered in the k^{th} branch, and

According to the formula (10), it can be concluded that the phases of the radio frequency signals transmitted by the elements of the antenna array varying with an

$${Δτ}^{′} = {\sum }_{m = 0}^{N - 1} {q}_{m} {2}^{m} Δτ \qquad ( 11 )$$

equal amount in order. In the case of a uniform linear array, if the physical distance between the antennas is d, the beam direction θ (beam directional radiation angle) is expressed as:

$$θ = {sin}^{- 1} \frac{c {Δτ}^{′}}{d} \qquad ( 12 )$$

where c is the rate at which electromagnetic waves travel in the air. It can be concluded from the equation (12) that the beam direction of the radio frequency can be changed by changing the value of Δτ′. According to the equation (11), in the structure of N-stage cascaded arrayed waveguide gratings, a total of 2^{N} different delay combinations can be obtained by changing the combination of the on and off states of the optical switches, delay combinations include 0, Δτ, 2Δτ, 3Δτ, . . . , (2^{N}−1)Δτ, thereby achieving 2^{N} different far-field beam directional radiation patterns (or beamforming) and the tuning thereof.

Based on the above statement, the present invention has the following advantages. 1). Based on the radio-over-fiber technique, a simple structure benefited by the features of large bandwidth and low loss of the photonic technique is provided, which can realize the beamforming of the radio frequency signal in a wide frequency band range, thereby transcending the bandwidth limitation of electronic-based solutions due to “electronic” bottlenecks. 2). The basic delay unit based on the multi-input multi-output arrayed waveguide gratings has the advantage of small size and easy integration. 3). 2^{N} delay combinations can be realized with the N-stage cascaded structure by simply controlling the combination of the on and off states of the optical switches in the photonic true-time delay module, thereby achieving 2^{N} different far-field radiation patterns, which can be widely used in the dynamic scenarios such as high speed railways, etc.

The above description merely shows the preferred embodiments of the present invention. It should be noted that, without departing from the essence of the method and the core device of the present invention, a number of changes and modifications can be made in the practical implementations, and these changes and modifications are covered by the scope of the present invention.

What is claimed is:

1. A radio-over-fiber communication beamforming device based on an arrayed waveguide grating, comprising: a multi-source laser array, a first wavelength division multiplexer, an electro-optic modulator, a programmable photonic true-time delay module, a second wavelength division multiplexer, a photoelectric detector set, and an antenna array;
wherein, the multi-source laser array, the first wavelength division multiplexer, the electro-optic modulator, the programmable photonic true-time delay module, the second wavelength division multiplexer, the photoelectric detector set, and the antenna array are successively connected to one another in a cascading manner;
the programmable photonic true-time delay module is formed by connecting a plurality of optical switches, and a plurality of arrayed waveguide gratings in a sequence alternatively, wherein a number of optical switches in the plurality of optical switches is one more than a number of the array waveguide gratings in the plurality of arrayed waveguide gratings; wherein, a first input port of each arrayed waveguide grating is connected to a first output port of an adjacent optical switch placed before the each arrayed waveguide grating in the sequence, a second output port of each optical switch is connected to a second input port of an optical switch following the each optical switch in the sequence, a first output port of each arrayed waveguide grating is connected to a first input port of a next optical switch following the each arrayed waveguide in the sequence; each of the plurality of the arrayed waveguide gratings has multiple input ports and multiple output ports, wherein a second input port of the each arrayed waveguide grating is connected to a second output port of the each arrayed waveguide grating, and a third input port of the each arrayed waveguide grating is connected to a third output port of the each arrayed waveguide grating;
the multi-source laser array is configured to output a plurality of continuous optical carriers of different wavelengths;
the first wavelength division multiplexer is configured to synthesize the plurality of continuous optical carriers of different wavelengths outputted by the multi-source laser array into one output signal;
the electro-optic modulator is configured to modulate and output the output signal of the first wavelength division multiplexer by a radio frequency signal;
the programmable photonic true-time delay module is configured to realize a final delay difference between the optical carriers of different wavelengths in an output signal of the electro-optic modulator by different combinations of on and off states of the plurality of optical switches according to control requirements;
the second wavelength division multiplexer is configured to process an output signal of the programmable photonic true-time delay module and output optical carriers of different wavelengths; and
the photoelectric detector set and the antenna array are configured to perform a photoelectric conversion on an output signal of the second wavelength division multiplexer to obtain radio frequency signals of different delays or different phases, and the radio frequency signals are sent out through the antenna array to form a far-field beam directional radiation pattern.

2. A radio-over-fiber communication beamforming method by using the radio-over-fiber communication beamforming device of claim 1, comprising the following steps:
outputting a plurality of continuous optical carriers of different wavelengths from the multi-wavelength continuous laser source array;
synthesizing the plurality of continuous optical carriers into one output by the first wavelength division multiplexer to enter the electro-optic modulator to be modulated by the radio frequency signal;
inputting a modulated output to the programmable photonic true-time delay module, wherein the programmable photonic true-time delay module comprises optical switches and a plurality of cascaded multi-input multi-output port arrayed waveguide gratings, with a selection of the optical switches, an optical signal enters corresponding arrayed waveguide gratings and the final delay difference between the optical carriers of different wavelengths is determined by a combination of the on and off states of the optical switches;
after being processed by the programmable photonic true-time delay module, processing the optical signal by the second wavelength division multiplexer to make the optical carriers of different wavelengths enter different branches respectively and undergo the photoelectric conversion by the photoelectric detector set to obtain radio frequency signals of different delays or different phases; and
sending out the radio frequency signals through the antenna array to form the far-field beam directional radiation pattern.

3. The radio-over-fiber communication beamforming method of claim 2, wherein, in different stages of the arrayed waveguide gratings, basic delays Δτ between adjacent wavelength channels present a geometric sequence with a common ratio of 2; in a structure of a plurality of arrayed waveguide gratings connected in a cascading manner, the basic delays of adjacent wavelength channels are Δτ, 2Δτ, 4Δτ, 8Δτ, . . . , 2^{N-1}Δτ, respectively, and N is a number of the cascading.

4. The radio-over-fiber communication beamforming method of claim 2, wherein, through the combination of the on and off states of the optical switches, a total of 2^{N} combinations of the basic delays between the adjacent wavelength channels can be realized in a multi-stage structure of N-stage arrayed waveguide gratings, 2^{N} combinations include 0, Δτ, 2Δτ, 3Δτ, . . . , (2^{N}−1)Δτ, respectively, and 2^{N} different far-field beam directional radiation patterns and a tuning of the 2^{N} different far-field beam directional radiation patterns are realized.
